(19) United States
(12) Patent Application Publication
(10) Pub. No.: US 2011/0148212 A1
(43) Pub. Date: Jun. 23, 2011

(54) ELECTRONIC DEVICE

(75) Inventor: Kazunori Kotani, Nara-shi (JP)

(73) Assignee: SANYO ELECTRIC CO., LTD., Osaka (JP)

(21) Appl. No.: 12/966,075

(22) Filed: Dec. 13, 2010

(30) Foreign Application Priority Data
Dec. 18, 2009 (JP) 2009-288257

(51) Int. Cl. H02J 4/00

(52) U.S. Cl. 307/80

(57) ABSTRACT

A projector includes an internal power supply, which supplies power to an electrical circuit in the projector, and a power supply terminal, which is electrically connected to a peripheral device. The projector also includes a switching circuit that switches between a power output state, in which power from the internal power supply is output via the power supply terminal to a peripheral device such as a remote control signal transmitter connected to the power supply terminal, and a power input state, in which power is input via the power supply terminal from a peripheral device such as a power supply device connected to the power supply terminal.

### CROSS-REFERENCE TO RELATED APPLICATIONS

This application is based upon and claims the benefit of priority from prior Japanese Patent Application No. 2009-288257, filed on Dec. 18, 2009, the entire contents of which are incorporated herein by reference.

### BACKGROUND OF THE INVENTION

The present invention relates to an electronic device including an internal power supply and a power supply terminal for a peripheral device.

A typical electronic device includes an electrical circuit and an internal power supply, which receives power from a commercial AC power supply and supplies the electrical circuit with power. When an electronic device includes an internal power supply and an output power supply terminal, which is electrically connected to a peripheral device, power is supplied from the internal power supply via the output power supply terminal to the peripheral device (e.g., Japanese Laid-Open Patent Publication No. 2004-135397).

A known electronic device includes an input power supply terminal, which is electrically connected to a peripheral device including an external power supply such as a rechargeable battery. In this case, the power input to the input power supply terminal from the external power supply of the peripheral device is supplied to an electrical circuit of the electronic device (e.g., Japanese Laid-Open Patent Publication No. 2009-117910).

### SUMMARY OF THE INVENTION

An electronic device that is capable of outputting power applicable to a peripheral device from an internal power supply and, at the same time, capable of inputting power from an external power supply of a peripheral device, is relatively large. Such an electronic device includes, for example, an output power supply terminal and input power supply terminal, which are discrete from each other. Thus, space for laying out the output and input power supply terminals becomes necessary. More specifically, when the output and input power supply terminals are arranged in discrete connectors, an increase in the number of connectors enlarges the electronic device. When discrete input and output power supply terminals are arranged in the same connector, the size of the connector is increased thereby enlarging the electronic device.

Further, an electronic device including discrete output and input power supply terminals is inconvenient when connecting a peripheral device to the electronic device. More specifically, when the output and input power supply terminals are arranged in discrete connectors, a user must check the connectors to determine which one is to be used to connect the peripheral device to the electronic device. Thus, the electronic device is inconvenient when connecting a peripheral device.

One aspect of the present invention is an electronic device including an internal power supply generating power for supply to an electrical circuit of the electronic device. A power supply terminal is electrically connectable to a peripheral device. A switching circuit is connected to the internal power supply, the power supply terminal, and the electrical circuit. The switching circuit switches between a power output state, in which power from the internal power supply is supplied to the peripheral device via the power supply terminal, and a power input state, in which power is input via the power supply terminal from the peripheral device when the peripheral device connected to the power supply terminal has an external power supply.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a block diagram of an electronic device according to a first embodiment of the present invention;

FIGS. 2(a) and 2(b) are block diagrams showing the electronic device connected to a peripheral device in different states;

FIG. 3 is a block diagram of the electronic device in a power output state;

FIG. 4 is a block diagram of the electronic device in a power input state;

FIG. 5 is a flowchart of a switching operation;

FIG. 6 is a block diagram showing an electronic device according to a second embodiment of the present invention in a state connected to a peripheral device;

FIG. 7 is a block diagram of an electronic device according to a third embodiment of the present invention; and

FIG. 8 is a block diagram of an electronic device according to a fourth embodiment of the present invention.

### DETAILED DESCRIPTION OF THE INVENTION

### First Embodiment

Embodiments of the present invention will now be discussed with reference to the drawings. Each drawing is a schematic view illustrating only elements required for describing an electronic device and a peripheral device. Other elements are not illustrated in the drawings and will not be described hereafter.

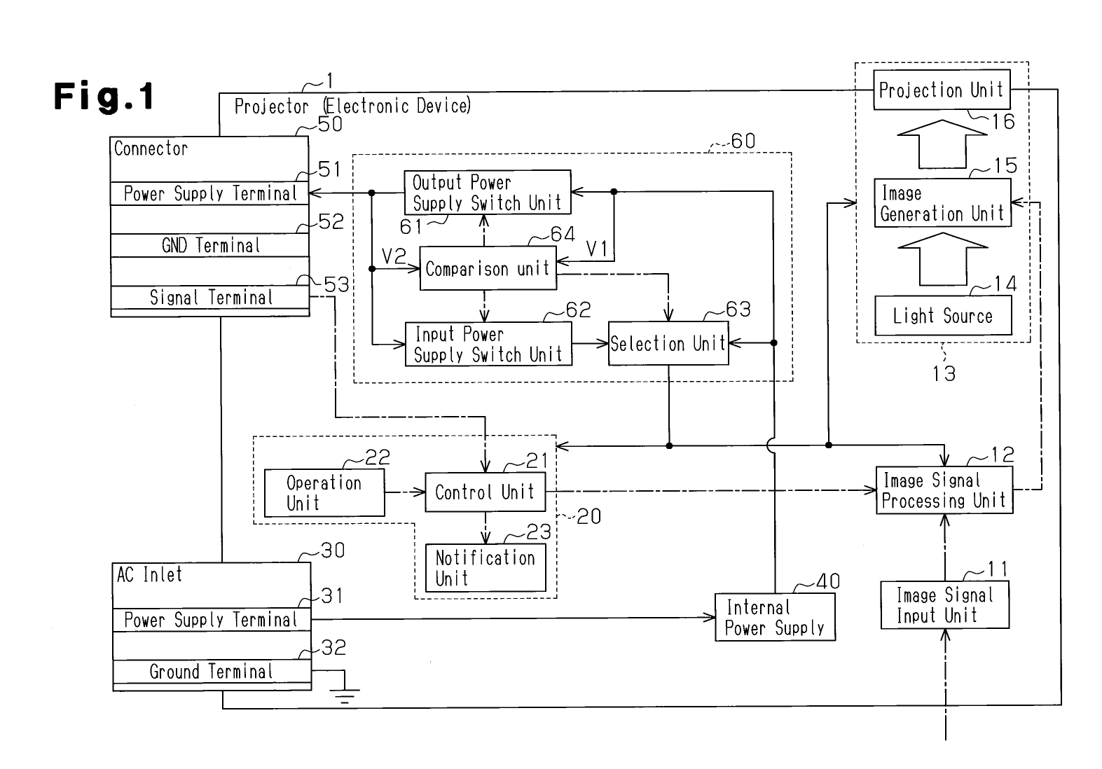

Referring to FIG. 1, a projector 1, which serves as an electronic device according to a first embodiment of the present invention, projects and displays an image onto a plane such as a screen or wall. The projector 1 includes an image signal input unit 11, an image signal processing unit 12, and an optical system 13. The image signal input unit 11 receives an input signal from an external device. The image signal processing unit 12 performs a predetermined signal process on the image signal. The optical system 13 projects and displays an image based on the processed image signal.

The image signal input unit 11 may be a connector or a wireless module. A connector would be a wired connection means such as an HDMI terminal or a VGA terminal, and a wireless module would be a wireless connection means such as an antenna.

The image signal processing unit 12 is an integrated circuit that performs various types of signal processing on image signals input to the projector 1. The image signal processing unit 12 processes an image signal based on a control signal provided from a control unit 21. Then, the image signal processing unit 12 sends the signal-processed image signal to an image generation unit 15 in the optical system 13.

The optical system 13 has optical components including a light source 14, the image generation unit 15, and a projection unit 16. The image generation unit 15 uses light emitted from the light source 14 to generate an image. The projection unit 16 enlarges and projects light corresponding to the image.

The light source 14 may be a gas-discharge lamp, such as a high pressure mercury-vapor lamp or a metal halide lamp, or a light emitting diode (LED) having high brightness. The control unit 21 provides the light source 14 with a control signal that switches the light source 14 on and off. The light emitted from the light source 14 (emission light) enters the image generation unit 15 via optical components such as an integrator lens and a reflection mirror (neither shown).

The image generation unit 15 may be an electro-optic device including, for example, a liquid crystal panel, which is a dot matrix type light valve, and a digital micromirror device (DMD), which has a grid-like array of micromirrors. The liquid crystal panel and DMD of the image generation unit 15 are driven by an image signal, which is provided from the image signal processing unit 12. In the image generation unit 15, the light emitted from the light source 14 is transmitted through the liquid crystal panel and reflected by the DMD to generate an image based on the image signal.

The projection unit 16 may be a group of lenses that enlarges the light of the image generated by the image generation unit 15 and projects the enlarged image out of the projector 1. In this manner, the projector 1 projects and displays the image onto a plane such as a screen or wall.

The projector 1 further includes the control unit 21, the operation unit 22, and a notification unit 23. The control unit 21 controls the signal processing of the image signal processing unit 12 and the lighting of the light source 14. The operation unit 22 is operated by a user of the projector 1. The notification unit 23 notifies the user of various types of information. The control unit 21, operation unit 22, and notification unit 23 form a standby system 20.

The control unit 21 is an integrated circuit that controls various parts of the projector 1. More specifically, the control unit 21 is formed, for example, by a microcomputer and executes a program stored in a memory (not shown) with a processor to generate control signals for controlling the image signal processing unit 12 and the light source 14. The control unit 21 controls the notification unit 23 by providing the notification unit 23 with a control signal that switches the information of which the user is notified.

The operation unit 22 may include, for example, buttons or a touch panel pushed by a user. The control unit 21 receives an electrical signal corresponding to the operation of the operation unit 22 and generates a control signal.

The notification unit 23 may include, for example, light emitting diodes (LEDs). In accordance with the information of which the user is notified, the control unit 21 changes the lighting mode of the notification unit 23. For example, the notification unit 23 emits green light in an image display mode, which is when the light source 14 is activated to display an image. In a standby mode, which is when the light source 14 is deactivated, the notification unit 23 emits red light.

The projector 1 includes electrical circuits, which consume power. In the description hereafter, the electrical circuits of the projector 1 include electrical circuits of the image signal processing unit 12, electrical circuits of the optical system 13, and electrical circuits of the standby system 20.

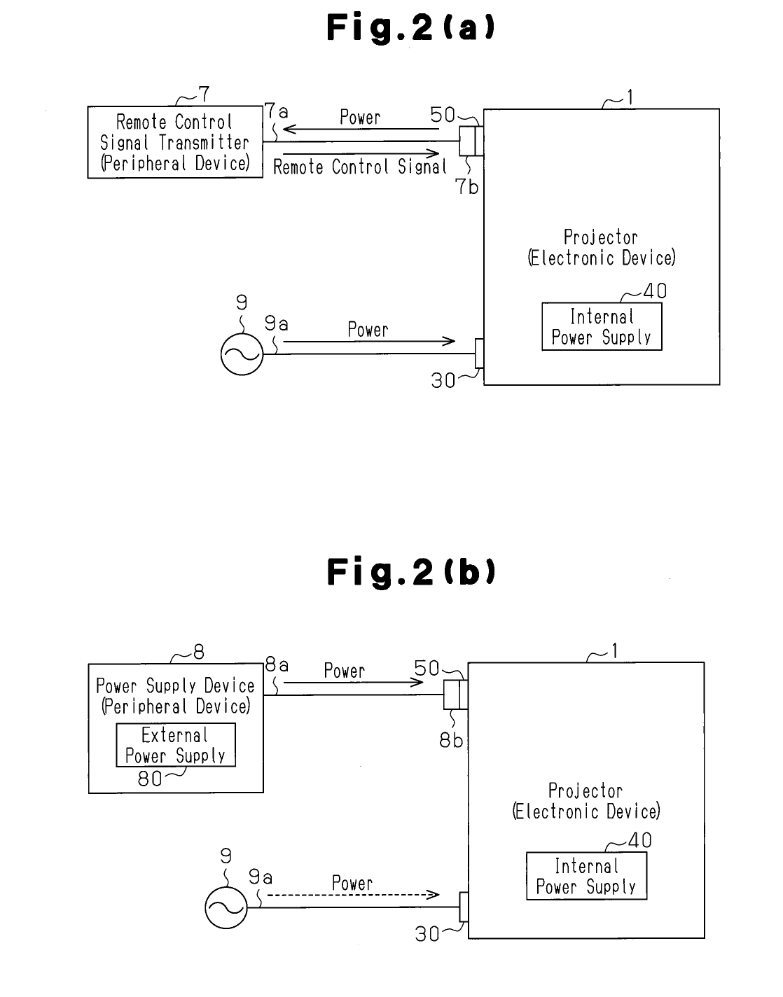

As elements for supplying power to the electrical circuits in the projector 1 from an AC power supply 9 (refer to FIG. 2), the projector 1 includes an AC inlet 30 and an internal power supply 40. A power cable 9a (refer to FIG. 2) is connected to the AC inlet 30. The internal power supply 40 converts the AC power obtained from the AC power supply 9 via the AC inlet 30 to power that is supplied to the electrical circuits in the projector 1.

The AC inlet 30 is a component for connecting the power cable 9a to the projector 1. The power cable 9a is further connected to the AC power supply 9, which is a commercial power supply. In the present embodiment, the AC inlet 30 is a three-pole AC inlet including a power supply terminal 31 and a ground terminal 32. The power supply terminal 31 is connected to two electric wires (i.e., a live wire and a neutral wire), which transmit AC power. The ground terminal is connected to a wire grounded for safety reasons (i.e., earth wire). The power supply terminal 31 may include two input power supply terminals (not shown) formed by discrete conductors to transmit AC power. The two input power supply terminals (not shown) of the power supply terminal 31 are each connected by a wire to the internal power supply 40. The two input power supply terminals of the power supply terminal 31 supply power from the AC power supply 9, which is located outside the projector 1, to the internal power supply 40.

The internal power supply 40 includes a power supply circuit that generates power for each electrical circuit in the projector 1. More specifically, the internal power supply 40 converts the AC power from the AC power supply 9 to DC power applicable for the electrical circuits of the image signal processing unit 12, DC power applicable for the electrical circuits of the optical system 13, and DC power applicable for the electrical circuits of the standby system 20. Then, the internal power supply 40 supplies the converted DC power to the corresponding electrical circuit. In this manner, the internal power supply 40 may be an AC/DC conversion circuit.

The power supplied to the electrical circuits of the projector 1 is stopped in accordance with the operation mode of the projector 1. The projector 1 is operable in an image display mode, in which an image is displayed, and a standby mode, in which an image is not displayed. In the standby mode, there is no need to drive the light source 14 and image generation unit 15 of the optical system 13. Thus, power is not supplied to the electrical circuits of the optical system 13 (i.e., lighting circuit of the light source 14 and drive circuits of the liquid crystal panel and DMD). Further, in the standby mode, there is no need for the image signal processing unit 12 to perform signal processing. Thus, power is not supplied to the electrical circuit (i.e., integrated circuit) of the image signal processing unit 12. In the image display mode, power is supplied to drive the image signal processing unit 12, the optical system 13, and the standby system 20. Thus, in comparison with the image display mode, less power is consumed by the projector 1 in the standby mode.

The electrical circuits of the standby system 20 are supplied with power even in the standby mode. Accordingly, the standby system 20 functions in the standby mode.

Further, the projector 1 includes a connector 50, which serves as a connection means allowing for connection with various peripheral devices (refer to FIG. 2). In the present embodiment, the connector 50 includes a power supply terminal 51, a GND terminal 52, and a signal terminal 53. A potential difference is produced between the power supply terminal 51 and GND terminal 52. The signal terminal 53 receives a remote control signal, which is one type of a control signal. The power supply terminal 51, GND terminal 52, and signal terminal 53 are each electrically connectable to a peripheral device.

The power supply terminal 51 and GND terminal 52 are each formed from a discrete conductor. The GND terminal 52 is a ground terminal connected to ground, which serves as a reference potential. The power supply terminal 51 and GND terminal 52 are each connected to the internal power supply 40 by a wire that transmits power from the internal power supply 40 to the power supply terminal 51. Further, to transmit power from the power supply terminal 51 to the electrical circuits in the projector 1, the power supply terminal 51 and GND terminal 52 are each electrically connected to electrical circuits other than those of the internal power supply 40 in the projector 1.

The signal terminal 53 is electrically connected by a signal wire to the control unit 21. The signal terminal 53 provides the control unit 21 with a remote control signal provided from outside the projector 1. The control unit 21 generates a control signal based on the received remote control signal.

The transfer of power between the projector 1 and a peripheral device when connecting the peripheral device to the connector 50 will now be discussed with reference to FIGS. 2(a) and 2(b). As shown in FIGS. 2(a) and 2(b), various peripheral devices are connectable to the connector 50 of the projector 1. That is, the connector 50 has a versatile shape allowing for connection with various peripheral devices. In the present embodiment, the power transferred between the projector 1 and a peripheral device connected to the connector 50 varies in accordance with the peripheral device.

As shown in FIG. 2(a), when a remote control signal transmitter 7, which serves as a peripheral device, is connected to the projector 1, the projector 1 receives a remote control signal, which is one type of a control signal, from the remote control signal transmitter 7.

Further, the projector 1 supplies the remote control signal transmitter 7 with the DC power required for operation. In this state, the power supply terminal 51 functions as an output power supply terminal. In such a power output state, the projector 1 supplies the remote control signal transmitter 7, which is connected to the power supply terminal 51, with the power generated by the internal power supply 40.

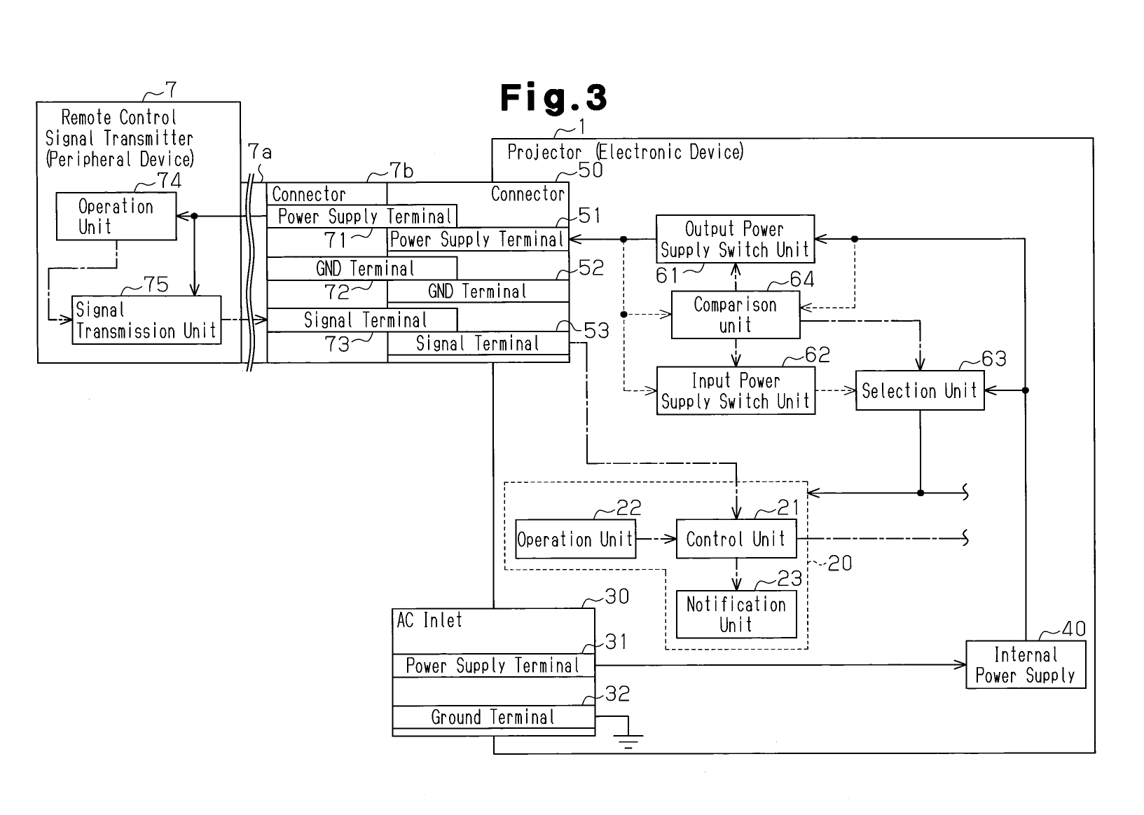

The power output state of the projector 1 will now be discussed in further detail with reference to FIGS. 2(a) and 3.

The remote control signal transmitter 7 is connected by a cable 7a to the projector 1. A connector 7b, which corresponds to the connector 50 of the projector 1, is arranged on the cable 7a. The connector 7b includes a power supply terminal 71, a GND terminal 72, and a signal terminal 73. The power supply terminal 71 and GND terminal 72 transmit DC power, and the signal terminal 73 transmits remote control signals. Connection of the connectors 50 and 7b electrically connects the power supply terminals 51 and 71, the GND terminals 52 and 72, and the signal terminals 53 and 73. The cable 7a is connected in a removable manner to the remote control signal transmitter 7.

As shown in FIG. 3, the remote control signal transmitter 7 includes an operation unit 74, which is manually operated, and a signal transmission unit 75, which transmits a remote control signal in accordance with the operation of the operation unit 74. The operation unit 74 and the signal transmission unit 75 are each connected by a wire to the power supply terminal 71 and GND terminal 72 of the connector 7b. Further, the signal transmission unit 75 is electrically connected by a signal wire to the signal terminal 73.

In the same manner as the operation unit 22, the operation unit 74 may include, for example, buttons or a touch panel pushed by the user. The signal transmission unit 75 receives an electrical signal corresponding to the operation of the operation unit 22.

The signal transmission unit 75 may be a signal transmission module that transmits a remote control signal. The signal transmission unit 75 generates a remote control signal based on an electronic signal received from the operation unit 74 and provides the generated remote control signal to the signal terminal 73.

When the connector 7b of the remote control signal transmitter 7 is connected to the connector 50 of the projector 1, the power supply terminals 51 and 71 supply DC power from the internal power supply 40 to the electrical circuits in the remote control signal transmitter 7 (i.e., the electrical circuits of the operation unit 74 and the signal transmission unit 75). Further, the signal terminal 73 provides a remote control signal from the signal transmission unit 75 to the signal terminal 53 of the projector 1.

As shown in FIG. 2(b), when a power supply device 8, which is a peripheral device, is connected to the projector 1, the power supply device 8 supplies the projector 1 with the DC power required to operate the projector 1. More specifically, the power supply device 8 includes an external power supply 80, which inputs power to the projector 1 via the power supply terminal 51. In such a power input state, the electrical circuits in the projector 1 receive DC power from the power supply terminal 51. The input voltage from the external power supply 80 is greater than or equal to the voltage input to an output power supply switch unit 61 from the internal power supply 40.

In the present embodiment, the power supply device 8 supplies the projector 1 with enough power for operating the entire projector 1. When the power supply device 8 is connected to the projector 1, it is preferable that the supply of power from the AC power supply 9 to the projector 1 be stopped. In this manner, when the external power supply 80 is used in lieu of the internal power supply 40 to supply power to the electrical circuits in the projector 1, the internal power supply 40 is not required to convert power with a low loss when in a standby state (standby mode), in which the consumed power is much smaller then when the light source 14 is lighted in the image display mode. Thus, a projector, which is active in a standby state, does not require an internal power supply to have an additional power supply unit (not shown) that lowers loss when converting power in the standby state. Such an additional power supply unit would enlarge the projector. In contrast, the internal power supply 40 of the illustrated projector 1 is not of a type that converts power with low loss. This prevents the projector 1 from being enlarged.

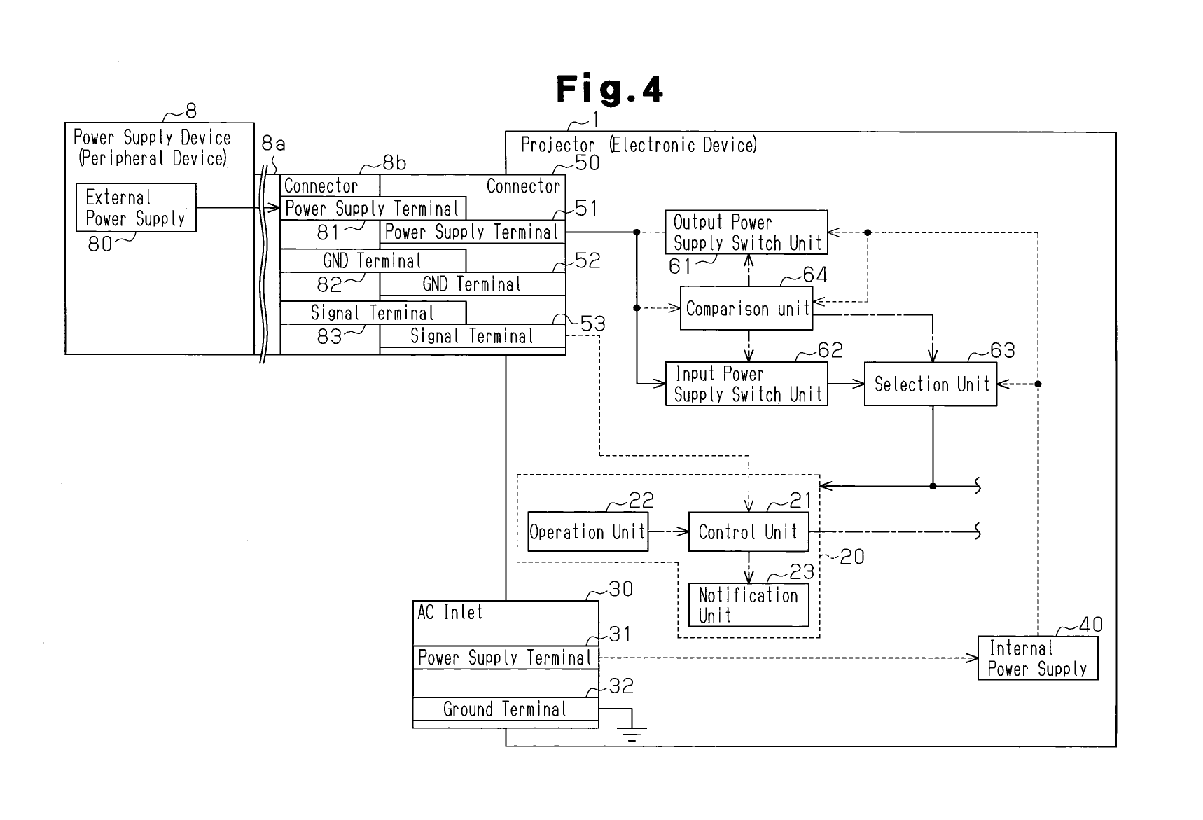

Referring to FIGS. 2(b) and 4, the power input state of the projector 1 will now be described in further detail.

The power supply device 8 is connected by a cable 8a to the projector 1. A connector 8b, which corresponds to the connector 50 of the projector 1, is arranged on the cable 8a. The connector 8b includes a power supply terminal 81, a GND terminal 82, and a signal terminal 83. The power supply terminal 81 and GND terminal 82 transmit DC power. Connection of the connectors 50 and 8b electrically connects the power supply terminals 51 and 81, the GND terminals 52 and 82, and the signal terminals 53 and 83. In the present embodiment, the power supply device 8 dos not transmit a remote control signal or the like. Thus, the signal terminal 83 is a dummy terminal, which is not connected to an electrical circuit in the power supply device 8.

The cable 8a is connected in a removable manner to the power supply device 8. Accordingly, in the present embodiment, the cables 7a and 8a may be commonly shared by various peripheral devices.

As shown in FIG. 4, the power supply device 8 is discrete from the AC power supply 9. The power supply device 8 includes an external power supply 80. The external power supply 80 is connected by a wire to the power supply terminal 81 and GND terminal 82 of the connector 8b. The external power supply 80 generates and outputs the DC power that is to be supplied to the electrical circuits in the projector 1. The external power supply 80 may be, for example, a rechargeable battery.

When the connector 8b of the power supply device 8 is connected to the connector 50 of the projector 1, the external power supply 80 supplies the electrical circuits in the projector 1 with DC power via the power supply terminals 81 and 51. The power supply terminal 51 functions as an input power supply terminal.

As described above, the projector 1 of the present embodiment is operable in a power output state, in which power is output from the internal power supply 40 to a peripheral device connected to the power supply terminal 51, and a power input state, in which power is input from the external power supply 80 of a peripheral device that is connected to the power supply terminal. A switching circuit 60, which switches the projector 1 between the power input state and the power output state, will now be described. The use of the switching circuit 60 allows for the projector 1 to use the same power supply terminal 51 as an output power supply terminal and an input power supply terminal.

As shown in FIG. 1, the switching circuit 60 includes the output power supply switch unit 61, an input power supply switch unit 62, and a selection unit 63. The output power supply switch unit 61 opens and closes an electrical circuit to supply power from the projector 1 to a peripheral device. The input power supply switch unit 62 opens and closes an electrical circuit to input power from a peripheral device to the projector 1. The selection unit 63 selects the power supply from which power is supplied.

The output power supply switch unit 61 is arranged along a wire connecting the internal power supply 40 and the connector 50. More specifically, the output power supply switch unit 61 may include a switch element such as a relay or transistor arranged along at least either one of a wire connecting the internal power supply 40 and the power supply terminal 51 and a wire connecting the internal power supply 40 and the GND terminal 52.

When the projector 1 is in a power output state, the output power supply switch unit 61 closes. As a result, current flows from the internal power supply 40 to the power supply terminal 51. The voltage input from the internal power supply 40 to the output power supply switch unit 61 is greater than or equal to the voltage output from the output power supply switch unit 61 to the power supply terminal 51. To ensure such voltage relationship, a diode (not shown) may be connected in series between the internal power supply 40 and the power supply terminal 51. The diode has an anode, which is connected to the internal power supply 40, and a cathode, which is connected to the power supply terminal 51. Due to the diode, the voltage input from the internal power supply 40 to the output power supply switch unit 61 is greater than the voltage output from the output power supply switch unit 61 to the power supply terminal 51 by an amount corresponding to the voltage of the diode in the forward direction (i.e., the decrease in voltage between the anode and cathode). When the output power supply switch unit 61 opens, current stops flowing from the internal power supply 40 to the connector 50, which includes the power supply terminal 51. This stops the transmission of DC current from the internal power supply 40 to the power supply terminal 51.

The input power supply switch unit 62 includes a wire connecting the connector 50 and electrical circuits in the projector 1. More specifically, the input power supply switch unit 62 may include a switch element such as a relay or transistor arranged along at least either one of a wire connecting the power supply terminal 51 and the electrical circuits in the projector 1 and a wire connecting the GND terminal 52 and the electrical circuits in the projector 1. When the projector 1 is in a power input state and the input power supply switch unit 62 closes, current flows from the power supply terminal 51 to the electrical circuits in the projector 1. The voltage input from the power supply terminal 51 to the input power supply switch unit 62 (i.e., the input voltage from the external power supply 80) is greater than or equal to the voltage input from the internal power supply 40 to the output power supply switch unit 61. When the input power supply switch unit 62 closes, current stops flowing from the power supply terminal 51 to the electrical circuits in the projector 1. This stops the transmission of DC power from the power supply terminal 51 to the electrical circuits in the projector 1.

The output power supply switch unit 61 and the input power supply switch unit 62 may be formed separately by discrete electronic components or be formed sharing the same electronic components. Further, when the output and input power supply switch units 61 and 62 each include a relay, the relay may be a contact type mechanical relay or a contactless type semiconductor relay. However, a semiconductor relay is preferable.

The selection unit 63 is arranged along a wire connecting the internal power supply 40 and power supply terminal 51 to the electrical circuits in the projector 1. The selection unit 63 may include a relay that switches the connection of the electrical circuits in the projector 1 between the internal power supply 40 and the power supply terminal 51. When the electrical circuits in the projector 1 are electrically connected to the internal power supply 40, DC power is supplied from the internal power supply 40 to the electrical circuits in the projector 1. However, the supply of power from the power supply terminal 51 to the electrical circuits in the projector 1 is stopped. In contrast, when the electrical circuits in the projector 1 are electrically connected to the power supply terminal 51, DC power is supplied from the power supply terminal 51 to the electrical circuits in the projector 1. However, the supply of power from the internal power supply 40 to the electrical circuits in the projector 1 is stopped. Accordingly, the selection unit 63 exclusively selects the power supplied to the electrical circuits in the projector 1 from either one of the power transmitted from the internal power supply 40 and the power transmitted from the power supply terminal 51. In the present embodiment, when the input power supply switch unit 62 is closed and the electrical circuits in the projector 1 are electrically connected to the power supply terminal 51, DC power is supplied from the power supply terminal 51 to the electrical circuits in the projector 1.

The switching circuit 60 includes a comparison unit 64, which compares voltages and controls the output power supply switch unit 61, the input power supply switch unit 62, and the selection unit 63 based on the comparison. Accordingly, the control of the output power supply switch unit 61, the input power supply switch unit 62, and the selection unit 63 is not dependent on the control unit 21. The switching circuit 60 is formed by simple logic circuits including the comparison unit 64.

The comparison unit 64 may include a voltage comparator that compares voltages between two points. When the output power supply switch unit 61 is closed, the comparison unit 64 is connected to both of a wire connected to the internal power supply 40 and a wire connected to the power supply terminal 51. The comparison unit 64 compares a voltage V1 from the internal power supply 40 and a voltage V2 from the power supply terminal 51 and provides an electrical signal based on the comparison to the output power supply switch unit 61, the input power supply switch unit 62, and the selection unit 63. The output power supply switch unit 61, the input power supply switch unit 62, and the selection unit 63 are operated in accordance with the electrical signal from the comparison unit 64. In this manner, the comparison unit 64 switches the output power supply switch unit 61 and the input power supply switch unit 62 between an open state and a closed state. The comparison unit 64 also switches the power supply selected by the selection unit 63.

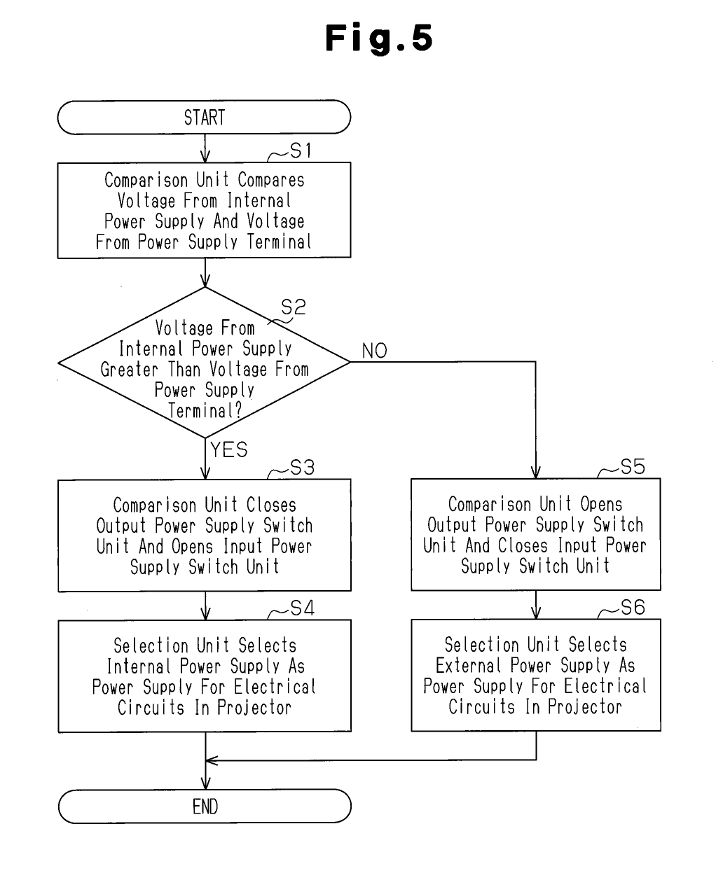

The switching of the power output state and power input state will now be discussed with reference to FIG. 5. Execution of the procedures shown in the flowchart of FIG. 5 may start cyclically or in response to detection of connection between the connector 50 and a peripheral device.

First, when the output power supply switch unit 61 is closed, the comparison unit 64 of the switching circuit 60 compares the voltage V1 from the internal power supply 40 with the voltage V2 from the power supply terminal 51 (step S1) to determine whether the voltage V1 is greater than the voltage V2 (step S2). When the remote control signal transmitter 7 is connected to the projector 1, power is not supplied from the remote control signal transmitter 7 to the projector 1. Thus, when the output power supply switch unit 61 is closed, the voltage V1 is greater than the voltage V2. When the power supply device 8 is connected to the projector 1, the power supply device 8 supplies the projector 1 with power for sufficiently operating the projector 1 at a voltage greater than or equal to the voltage V1 input to the output power supply switch unit 61 from the internal power supply 40. Thus, the voltage V2 is greater than or equal to the voltage V1. Accordingly, step S2 is performed to determine the type of peripheral device connected to the projector 1.

When the voltage V1 from the internal power supply 40 is greater than the voltage V2 from the power supply terminal 51 (YES in step S2), the comparison unit 64 provides the output power supply switch unit 61 and input power supply switch unit 62 with an electrical signal (switching signal) that switches the projector 1 to a power output state (step S3). In response to the electrical signal, the output power supply switch unit 61 closes, and the input power supply switch unit 62 opens. In this manner, the projector 1 switches to a power output state in step S3, and the power supply terminal 51 functions as an input power supply terminal.

In step S4, since the voltage V1 from the internal power supply 40 has been determined to be greater than the voltage V2 from the power supply terminal 51, the comparison unit 64 provides the selection unit 63 with an electrical signal for electrically connecting the electrical circuits in the projector 1 with the internal power supply 40. In response to the electrical signal, the selection unit 63 selects the power transmitted from the internal power supply 40 as the power supplied to the electrical circuits in the projector 1.

When the voltage V1 from the internal power supply 40 is not greater than the voltage V2 from the power supply terminal 51 (NO in step S2), the comparison unit 64 provides the output power supply switch unit 61 and input power supply switch unit 62 with an electrical signal (switching signal) that switches the projector 1 to a power input state (step S5). In response to the electrical switch, the output power supply switch unit 61 opens, and the input power supply switch unit 62 closes. In this manner, the projector 1 switches to a power input state in step S5, and the power supply terminal 51 functions as an input power supply terminal.

In step S6, since the voltage V1 from the internal power supply 40 has been determined as not being greater than the voltage V2 from the power supply terminal 51, the comparison unit 64 provides the selection unit 63 with an electrical signal for electrically connecting the electrical circuits in the projector 1 with the power supply terminal 51. In response to the electrical signal, the selection unit 63 selects the power transmitted from the power supply terminal 51 as the power supplied to the electrical circuits in the projector 1.

The present embodiment has the advantages described below.

(1) The projector 1 includes the internal power supply 40, which supplies power to the electrical circuits in the projector 1 with power, and the power supply terminal 51, which is electrically connected to a peripheral device, such as the remote control signal transmitter 7 or the power supply device 8. The projector 1 further includes the switching circuit 60 that switches the projector 1 between a power output state and a power input state. In the power output state, power is output from the internal power supply 40 to the remote control signal transmitter 7, which is the peripheral device connected to the power supply terminal 51. In the power input state, power is input from the external power supply 80 of the power supply device 8, which is the peripheral device connected to the power supply terminal 51. The switching circuit 60 switches between a state in which power is supplied to a peripheral device from the internal power supply 40 via the power supply terminal 51 and a state in which power is input from the peripheral device via the power supply terminal 51. Thus, in accordance with the connected peripheral device, the same power supply terminal 51 may be used as an output power supply terminal, which outputs power, and an input power supply terminal, which inputs power. This allows for the same power supply terminal 51 to be used in accordance with the connected peripheral device as an output power supply terminal, which outputs power, and an input power supply terminal, which inputs power. Accordingly, the same power supply terminal 51 may be used for the output and input of power. Thus, the projector 1 has fewer connectors than a projector that includes discrete output and input power supply terminals. Further, the connector 50 does not have to be enlarged. Thus, the projector 1 may be reduced in size. Further, the same connector 50 may be used for connection of peripheral devices. Thus, a user connecting the projector 1 and a peripheral device does not have to locate a connector that conforms to the peripheral device. This facilitates the location of the connector 50 to which a peripheral device is to be connected. Accordingly, the convenience for connecting a peripheral device to the electronic device is improved.

(2) The switching circuit 60 includes the selection unit 63, which selects either one of the power supplied from the internal power supply 40 and the power input and supplied from the external power supply 80 as the power supplied to the electrical circuits in the projector 1. For example, the selection unit 63 selects the power supplied from the external power supply 80 as the power supplied to the electrical circuits in the projector 1 so that there is no need for supplying power from the internal power supply 40 to the electrical circuits in the projector 1.

(3) When the external power supply 80 is not connected to the connector 50, the internal power supply 40 converts the AC power supplied from the AC power supply 9 to DC power, which is supplied to the electrical circuits in the projector 1. When the external power supply 80 is connected to the connector 50, DC power is supplied from the external power supply 80. Thus, the DC power may be supplied to the electrical circuits in the projector 1 without undergoing AC/DC conversion. Accordingly, when the power supplied from the external power supply 80 is selected as the power supplied to the electrical circuits in the projector 1, power loss in AC/DC conversion by the internal power supply 40 is reduced.

(4) The switching circuit 60 automatically, not manually, switches between the power output state and the power input state. This eliminates the need for a user to manually switch between a power output state and a power input state.

(5) The switching circuit 60 includes the comparison unit 64 that compares the voltage V2 at the power supply terminal 51 connected to a peripheral device (i.e., the remote control signal transmitter 7 or power supply device 8) and the voltage V1 of the power supplied from the internal power supply 40. Based on the comparison, the selection unit 63 switches between the power output state and the power input state. Thus, the power output state and the power input state are automatically switched in accordance with the peripheral device connected to the power supply terminal 51 without being controlled by an external device (not shown).

### Second Embodiment

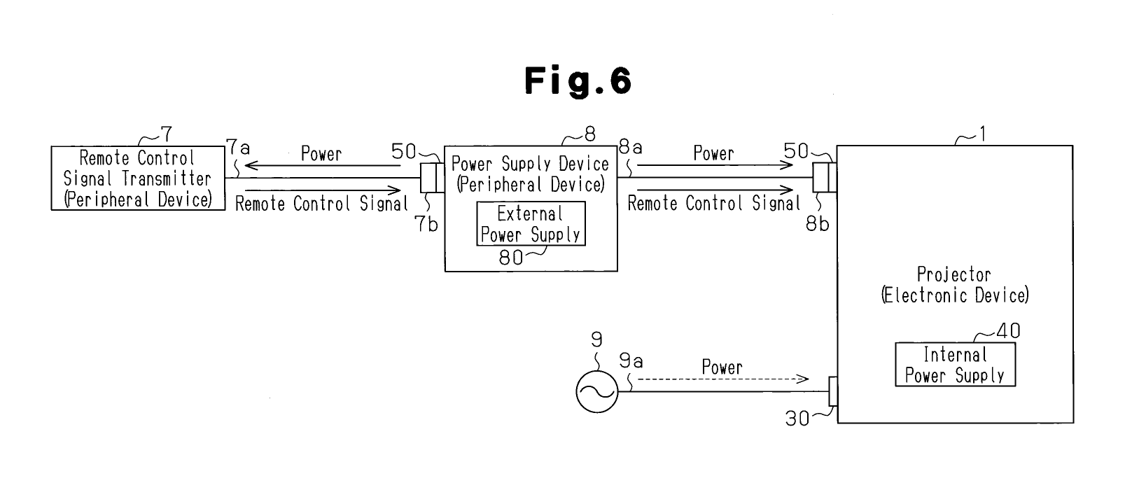

A second embodiment will now be discussed with reference to FIG. 6. To avoid redundancy, like or same reference numerals are given to those components that are the same as the corresponding components of the first embodiment. Such components will not be described in detail.

As shown in FIG. 6, a power supply device 8 and a remote control signal transmitter 7 are connected in series (i.e., a daisy chain) to a single connector 50 of a projector 1. More specifically, the remote control signal transmitter 7 is connected via the power supply device 8 to the projector 1.

In the same manner as the projector 1, the power supply device 8 of the present embodiment, includes a connector 50, which has terminals electrically connected to the remote control signal transmitter 7. In the same manner as the connector 50 of the projector 1, the connector 50 of the power supply device 8 includes a power supply terminal, a GND terminal, and a signal terminal. Thus, the remote control signal transmitter 7 is connectable to the power supply device 8 by a cable 7a, which has a connector 7b.

The power supply device 8 has an external power supply 80 that supplies DC power to electrical circuits in the remote control signal transmitter 7. Thus, in the present embodiment, the power supply device 8 supplies DC power to the remote control signal transmitter 7 in addition to the projector 1.

The remote control signal transmitter 7 includes a signal transmission unit 75 (refer to FIG. 3) that outputs a remote control signal, which is indirectly input to a signal terminal 53 (refer to FIG. 1) of the projector 1 via the power supply device 8. The power supply device 8 has a signal terminal 83 (refer to FIG. 4) connected to the signal terminal in the connector 50 of the power supply device 8. Thus, the signal terminal 83 is not a dummy terminal like in the first embodiment. A combination of the projector 1, the power supply device 8, and the remote control signal transmitter 7 may be referred to as an electronic device system.

The electronic device system of the second embodiment has the following advantage.

(6) A plurality of peripheral devices (i.e., the remote control signal transmitter 7 and the power supply device 8) are connectable in series to the projector 1. Thus, the single power supply terminal 51 of the projector 1 may be used to simultaneously connect the remote control signal transmitter 7 and power supply device 8 to the projector 1.

### Third Embodiment

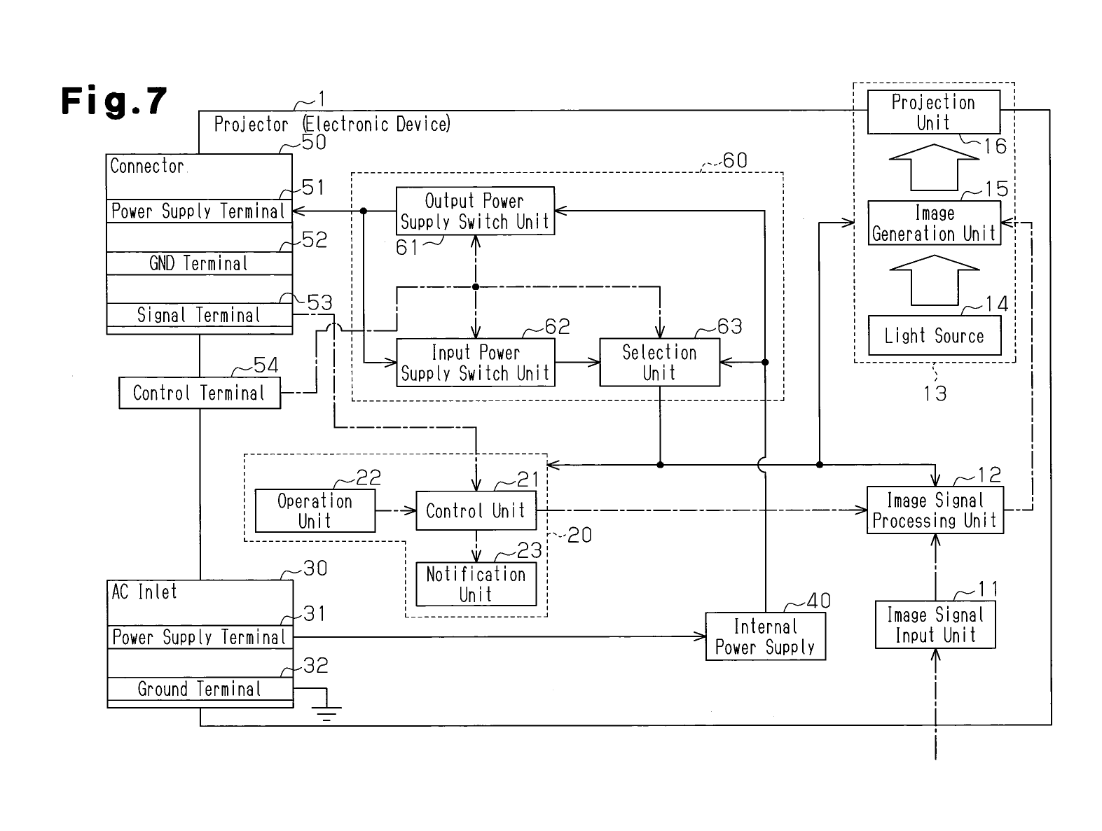

A third embodiment of a projector 1 will now be described with reference to FIG. 7. To avoid redundancy, like or same reference numerals are given to those components that are the same as the corresponding components of the first embodiment. Such components will not be described in detail.

The projector 1 of the present embodiment includes a control terminal 54 in lieu of the comparison unit 64 (refer to FIG. 1). The control terminal 54 is a control signal input unit that receives a control signal from an external device (not shown) such as a computer.

The control terminal 54 is electrically connected to an external device. The control terminal 54 may be arranged in a connector (not shown), which is discrete from the connector 50 that includes the power supply terminal 51. It is preferable that the connector 50 connected to the peripheral device and the other connector including the control terminal 54 be shaped differently so that they may be visually distinguished by a user when connecting a peripheral device to the projector 1.

An output power supply switch unit 61, an input power supply switch unit 62, and a selection unit 63 are operated by electrical signals provided from the external device. For example, the opening and closing of the output power supply switch unit 61 and the input power supply switch unit 62 are controlled by the external device. The selection of a power supply by the selection unit 63 is also controlled by the external device.

More specifically, when the remote control signal transmitter 7 is connected to the projector 1 and a control signal (switching signal) for switching to a power output state is input from the external device to the control terminal 54, the output power supply switch unit 61 and the input power supply switch unit 62 are operated in accordance with the signal in the same manner as in step S3. Further, the selection unit 63 is operated in the same manner as in step S4.

When the power supply device 8 is connected to the projector 1 and a control signal (switching signal) for switching to a power input state is input from the external device to the control terminal 54, the output power supply switch unit 61 and the input power supply switch unit 62 are operated in accordance with the signal in the same manner as step S5. Further, the selection unit 63 is operated in the same manner as in step S6.

In addition to advantages (1) to (4), the present embodiment has the following advantage.

(7) The projector 1 includes the control terminal 54, which receives a control signal output from an external device such as a computer. Based on the control signal input to the control terminal 54, that is, the control signal output from the external device, the projector 1 is switched between the power output state, in which power is output from the internal power supply 40 to the remote control signal transmitter 7 that serves as a peripheral device, and a power input state, in which power is input from the external power supply 80 of the power supply device that serves as a peripheral device. Thus, the external device automatically switches the projector 1 between a power output state and a power input state.

### Fourth Embodiment

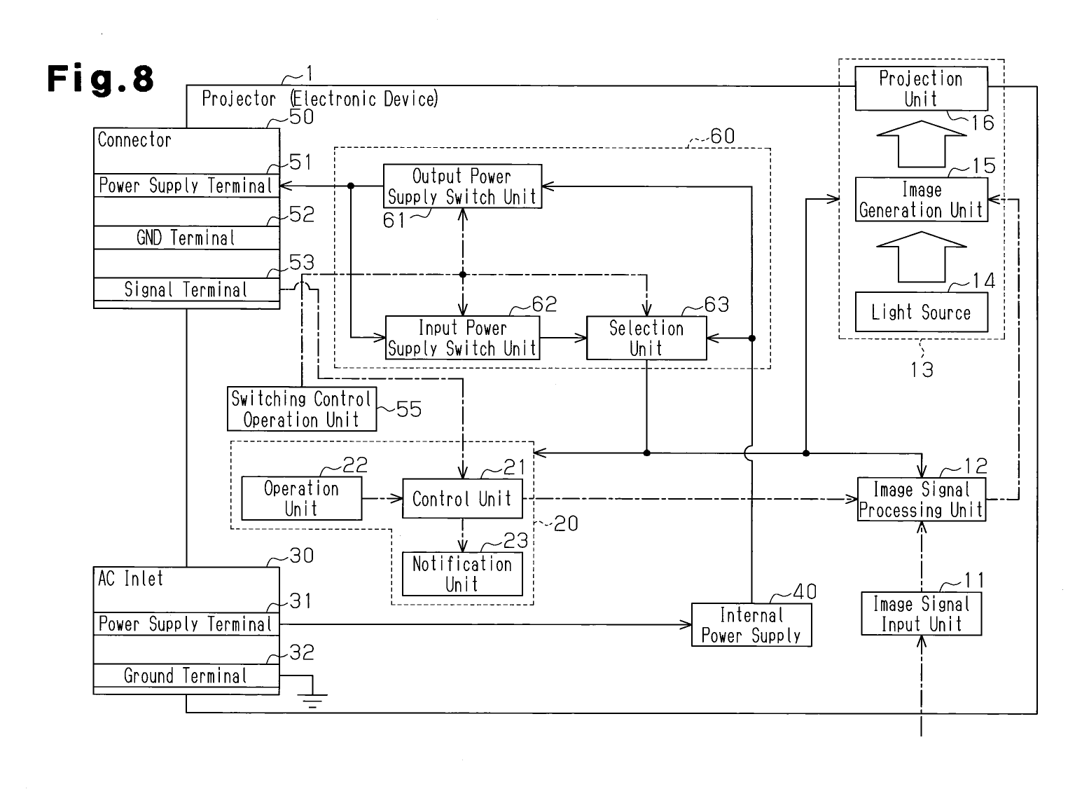

A fourth embodiment of a projector 1 will now be described with reference to FIG. 8. To avoid redundancy, like or same reference numerals are given to those components that are the same as the corresponding components of the first embodiment. Such components will not be described in detail.

The projector 1 of the present embodiment includes a switching control operation unit 55. In the same manner as the operation unit 22, the switching control operation unit 55 includes, for example, buttons or a touch panel pushed by a user. An electrical signal corresponding to the operation of the switching control operation unit 55 is provided to the output power supply switch unit 61, the input power supply switch unit 62, and the selection unit 63. The user operates the switching control operation unit 55 to switch the output power supply switch unit 61 and the input power supply switch unit 62 between an open state and a closed state. The user also operates the switching control operation unit 55 to switch the power supply selected by the selection unit 63.

In one example, the switching control operation unit 55 is operated so that power is output to a remote control signal transmitter 7, which is connected to the projector 1. This operates the output power supply switch unit 61 and the input power supply switch unit 62 in accordance with an electrical signal (switching signal) for switching the projector 1 to a power output state in the same manner as in step S3. Further, the selection unit 63 is operated in the same manner as in step S4.

The switching control operation unit 55 may be operated so that power is input from a power supply device 8, which is connected to the projector 1. This operates the output power supply switch unit 61 and the input power supply switch unit 62 in accordance with an electrical signal (switching signal) for switching the projector 1 to a power input state in the same manner as in step S5. Further, the selection unit 63 is operated in the same manner as in step S6.

In addition to advantages (1) to (3), the present embodiment has the following advantage.

(8) The projector 1 includes the switching control operation unit 55, which is manually operated. In accordance with the operation of the switching control operation unit 55, the projector 1 is switched between a power output state and a power input state. More specifically, in accordance with the operation of the manually operated switching control operation unit 55, the projector 1 is switched between a power output state, in which power is output from an internal power supply 40 to a remote control signal transmitter 7 serving as a peripheral device, and a power input state, in which power is input from an external power supply 80 of a power supply device serving as a peripheral device. Thus, a user of the projector 1 may operate the switching control operation unit 55 to select whether to use the power supply terminal 51 as an output power supply terminal or an input power supply terminal.

It should be apparent to those skilled in the art that the present invention may be embodied in many other specific forms without departing from the spirit or scope of the invention. Particularly, it should be understood that the present invention may be embodied in the following forms, which may be combined.

In each of the embodiments discussed above, the control unit 21 may control the output power supply switch unit 61, the input power supply switch unit 62, and the selection unit 63.

For example, the first embodiment may be modified so that the control unit 21 obtains the result of the comparison between the voltage V1 and the voltage V2 by the comparison unit 64. The control unit 21 may then output an electrical signal based on the comparison to the output power supply switch unit 61, the input power supply switch unit 62, and the selection unit 63. Further, for example, the third embodiment may be modified so that the control terminal 54 provides the control unit 21 with a control signal from the external device. In this case, the control unit 21 controls the output power supply switch unit 61, the input power supply switch unit 62, and the selection unit 63 based on the control signal from the external device. The fourth embodiment may also be modified so that the control unit 21 is connected to the switching control operation unit 55. In this case, the control unit 21 controls the output power supply switch unit 61, the input power supply switch unit 62, and the selection unit 63 with an electrical signal corresponding to the operation of the switching control operation unit 55.

In the third embodiment, the signal terminal 53 may also function as the control terminal 54. Further, in the fourth embodiment, the operation unit 22 may function as the switching control operation unit 55.

When the projector 1 is in a power input state, the internal power supply 40 and the external power supply 80 may both supply power to the electrical circuits in the projector 1. That is, the selection unit 63 may be eliminated, which selects either one of the power supplied from the internal power supply 40 and the power input and supplied from the external power supply 80.

The power transmitted from the power supply terminal 51 does not have to be supplied to each one of the electrical circuits of the image signal processing unit 12, the optical system 13, and the standby system 20. For example, power from the external power supply 80 may be supplied to only the electrical circuits of the standby system 20. In this case, when the projector 1 is connected to the power supply device 8 and is in a standby mode, the power supplied from the external power supply 80 may be selected as the power supplied to the electrical circuits of the standby system 20.

In the embodiments discussed above, peripheral devices other than the remote control signal transmitter 7 and the power supply device 8 may be connected to the projector 1. Further, a peripheral device including the external power supply 80 may have a function that differs from the power supply function. In this case, the internal power supply 40 of the projector 1 may output power to the peripheral device including the external power supply 80.

In this case, in addition to switching between the power output state and the power input state in accordance with the type of the connected peripheral device, when the same peripheral device is connected, the present invention may be applied to switch between the power output state and the power input state in accordance with the condition of the peripheral device. This obtains advantages similar to the advantages described above.

In the power input state, the internal power supply 40 may stop generating power. This prevents power loss in the internal power supply 40.

The present invention may be applied to an electronic device other than the projector 1, such as a television or audio equipment.

The present examples and embodiments are to be considered as illustrative and not restrictive, and the invention is not to be limited to the details given herein, but may be modified within the scope and equivalence of the appended claims.

What is claimed is:

1. An electronic device comprising:
an internal power supply for generating power for supply to an electrical circuit of the electronic device;
a power supply terminal electrically connectable to a peripheral device; and
a switching circuit connected to the internal power supply, the power supply terminal, and an electrical circuit of the electronic device, wherein the switching circuit switches between a power output state, in which power from the internal power supply is supplied to the peripheral device via the power supply terminal, and a power input state, in which power is input via the power supply terminal from the peripheral device when the peripheral device connected to the power supply terminal has an external power supply.

2. The electronic device according to claim 1, wherein the switching circuit includes a selection unit that selects as the power supplied to the electrical circuit either one of the power supplied from the internal power supply and the power input from the external power supply of the peripheral device via the power supply terminal.

3. The electronic device according to claim 1, further comprising:
an AC inlet connectable to an AC power supply;
wherein the internal power supply converts AC power supplied from the AC power supply via the AC inlet to DC power and supplies the electrical circuit with the DC power; and
the power supply terminal receives DC power from the external power supply of the peripheral device.

4. The electronic device according to claim 1, wherein the switching circuit automatically switches between the power output state and the power input state without requiring a manual operation.

5. The electronic device according to claim 4, wherein the switching circuit includes a comparison circuit that compares voltage at the power supply terminal when the peripheral device is connected thereto, with voltage supplied from the internal power supply; and
the switching circuit switches between the power output state and the power input state based on the comparison of the comparison unit.

6. The electronic device according to claim 4, further comprising:
a control signal input unit connectable to an external device to receive a control signal from the external device;
wherein the switching circuit switches between the power output state and the power input state based on the control signal provided to the control signal input unit.

7. The electronic device according to claim 1, further comprising:
an operation unit that is manually operable;
wherein the switching circuit switches between the power output state and the power input state in accordance with operation of the operation unit.

8. The electronic device according to claim 1, wherein a plurality of peripheral devices are connectable in series to the power supply terminal.

9. The electronic device according to claim 1, wherein the power supply terminal functions as an output power supply terminal and an input power supply terminal, and wherein the switching circuit exclusively switches between the power output state and the power input state.

10. The electronic device according to claim 9, wherein the switching circuit switches to the power input state when the power supply terminal is connected to the external power supply of the peripheral device; and
the switching circuit switches to the power output state when the power supply terminal is disconnected from the external power supply of the peripheral device.

11. The electronic device according to claim 10, wherein the electrical circuit includes a standby system control unit, and wherein in the power input state, the internal power supply stops generating power while the switching circuit operates such that the standby system control unit is powered by DC power input from the peripheral device via the power supply terminal.

12. An electronic device for use with a peripheral device of first type that receives power and second type that supplies power, the electronic device comprising:
an electrical circuit;
an internal power supply for generating power and supplying the power to the electrical circuit;
a power supply terminal electrically connectable to a peripheral device of either the first type or the second type; and
a switching circuit connected to the internal power supply, the power supply terminal, and the electrical circuit, wherein the switching circuit switches between a power output state, in which power from the internal power supply is supplied to the first type of peripheral device when connected to the power supply terminal, and a power input state, in which power is input from the second type of peripheral device when connected to the power supply terminal.

13. The electronic device according to claim 12, wherein the switching circuit includes a selection unit that selects as the power supplied to the electrical circuit either one of power supplied from the internal power supply and power input from the second type of peripheral device when connected to the power supply terminal.

14. The electronic device according to claim 12, wherein the electronic device is for use with an AC power supply, the electronic device further comprising:
an AC inlet connectable to the AC power supply;
wherein the internal power supply converts AC power supplied from the AC power supply via the AC inlet to DC power and supplies the electrical circuit with the DC power; and
the power supply terminal receives DC power from the second type of peripheral device when a peripheral device of the second type is connected to the power supply terminal.

15. The electronic device according to claim 12, wherein the switching circuit automatically switches between the power output state and the power input state without requiring a manual operation.

16. The electronic device according to claim 15, wherein the switching circuit includes a comparison circuit that compares voltage at the power supply terminal when a peripheral device is connected thereto, with voltage supplied from the internal power supply; and
the switching circuit switches between the power output state and the power input state based on the comparison of the comparison unit.

17. The electronic device according to claim 15, further comprising:
a control signal input unit connectable to an external device to receive a control signal from the external device;
wherein the switching circuit switches between the power output state and the power input state based on the control signal provided to the control signal input unit.

18. The electronic device according to claim 12, further comprising:
an operation unit that is manually operable;
wherein the switching circuit switches between the power output state and the power input state in accordance with operation of the operation unit.

19. The electronic device according to claim 12, wherein a plurality of peripheral devices are connectable in series to the power supply terminal.

20. The electronic device according to claim 12, wherein the power supply terminal functions as an output power supply terminal and an input power supply terminal, and wherein the switching circuit exclusively switches between the power output state and the power input state.
